(19) United States
(12) Patent Application Publication
(10) Pub. No.: US 2015/0012680 A1
(43) Pub. Date: Jan. 8, 2015

(54) EXPANSION CARD ASSEMBLY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: BO TIAN, Shenzhen (CN); KANG WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/947,782

(22) Filed: Jul. 22, 2013

(30) Foreign Application Priority Data
Jul. 4, 2013 (CN) 2013102780484

(51) Int. Cl. G06F 13/40

(52) U.S. Cl. CPC G06F 13/409
USPC 710/301

(57) ABSTRACT

An expansion card assembly includes a first expansion card with a first circuit board, a first expansion slot, and a second expansion card with a second circuit board. A first edge connector is arranged on a bottom edge of the first circuit board and is inserted into a second expansion slot of a motherboard. A second edge connector is arranged on a top edge of the first circuit board and is inserted into the first expansion slot. A third edge connector is arranged on a bottom edge of the second circuit board and is electrically connected to pins of the first expansion slot opposite to the first expansion card.

### BACKGROUND

1. Technical Field

The present disclosure relates to an expansion card assembly.

2. Description of Related Art

At present, peripheral component interconnection express (PCIe) devices can be inserted into PCIe slots of a motherboard, to expand system function. However, the number of the PCIe slots arranged on the motherboard is limited and it is difficult to expand additional system function.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an expansion card assembly in accordance with an embodiment; wherein the expansion card assembly includes a first expansion card.

FIG. 2 is an assembled, isometric view of the first expansion card of FIG. 1 connected to a motherboard.

FIG. 3 is an assembled, isometric view of the expansion card assembly of FIG. 1 connected to a motherboard.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

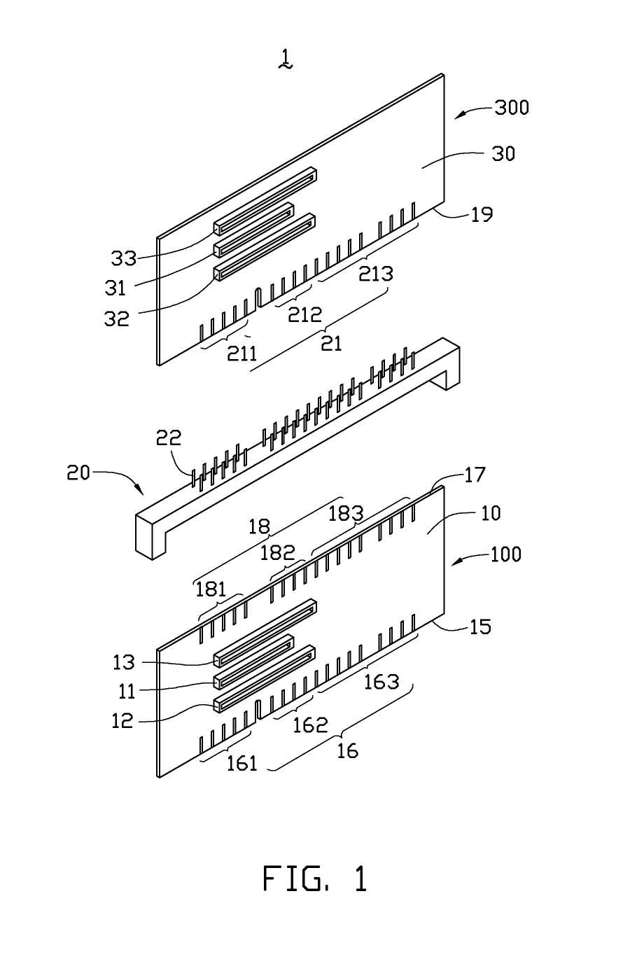

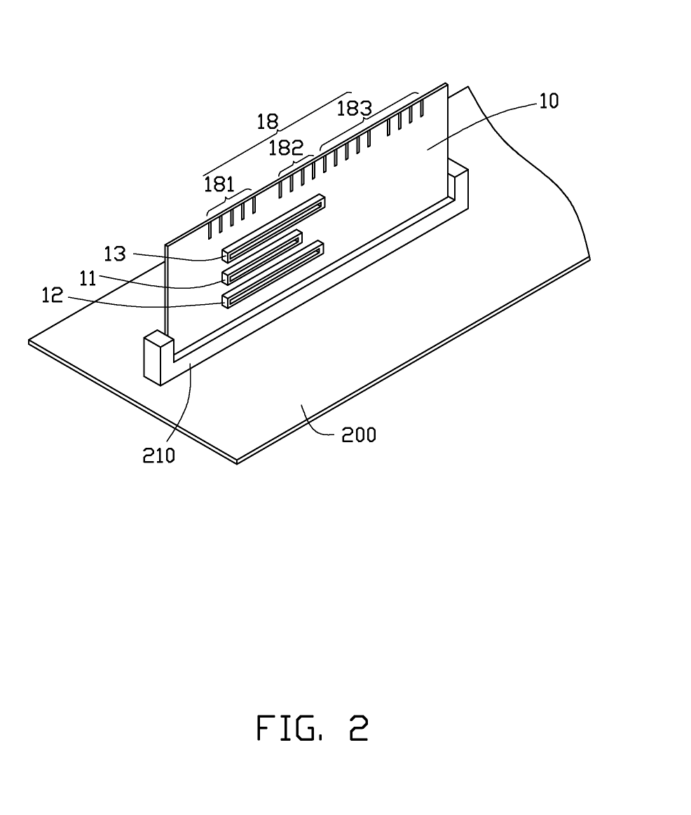

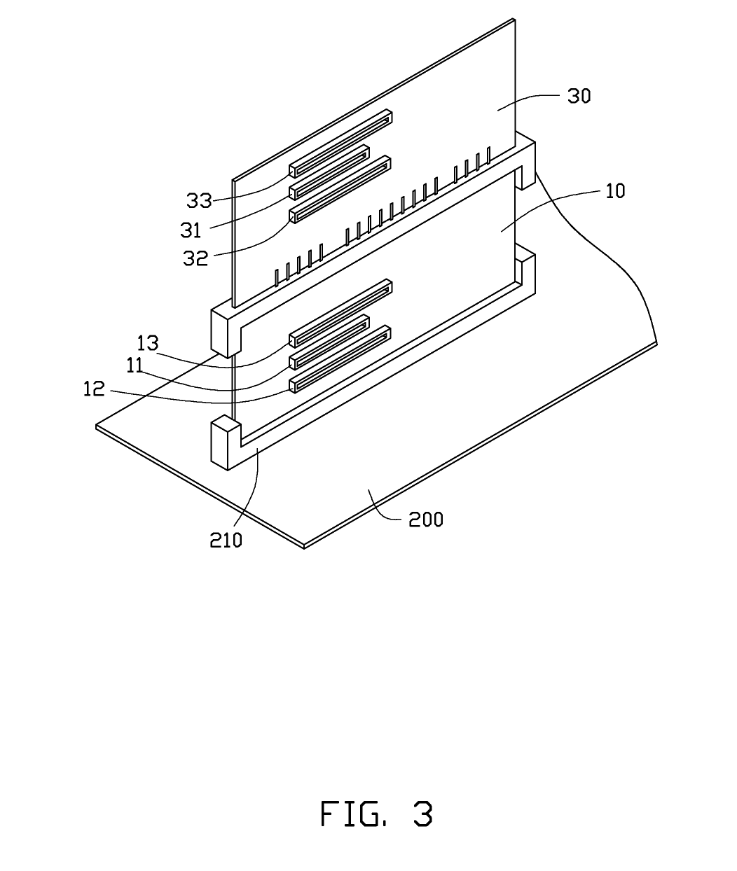

FIGS. 1 to 3 show an expansion card assembly 1 in accordance with an embodiment. The expansion card assembly 1 includes a first expansion card 100, an expansion slot 20, and a second expansion card 300. In one embodiment, the expansion slot 20 is a peripheral component interconnection express (PCIe) slot.

The first expansion card 100 includes a substantially rectangular circuit board 10. A plurality of PCIe slots 11-13, such as a PCIe X4 slot, a PCIe X8 slot, and a PCIe X16slot are arranged on the circuit board 10. In other embodiments, the number of the PCIe slots can be changed according to need. An edge connector 16 is arranged on a bottom edge 15 of the circuit board 10, to be inserted into an expansion slot 210, such as a PCIe slot, of a motherboard 200. The edge connector 16 includes a plurality of power pins 161, a plurality of ground pins 162, and a plurality of signal pins 163. The power pins 161 are connected to power pins of the PCIe slots 11-13. The ground pins 162 are connected to a ground layer (not shown) of the circuit board 10. The signal pins 163 are connected to signal pins of the PCIe slots 11-13.

An edge connector 18 is arranged on a top edge 17 of the circuit board 10, to be inserted into the expansion slot 20. The edge connector 18 includes a plurality of power pins 181, a plurality of ground pins 182, and a plurality of signal pins 183. The power pins 181 are connected to the power pins 161. The ground pins 182 are connected to the ground layer of the circuit board 10. The signal pins 183 are connected to the signal pins 163. In one embodiment, each of the edge connectors 16 and 18 is in accordance with PCIe X16 standards. In other embodiments, the edge connectors 16 and 18 may accord with PCIe X4 standards or PCIe X8 standards. When the edge connector 16 is in accordance with PCIe X4 standards, the PCIe X4 slot, the PCIe X8 slot, and the PCIe X16 slot of the circuit board 10 both receive PCIe X4 devices. When the edge connector 16 is in accordance with PCIe X8 standards, the PCIe X4 slot receives a PCIe X4 device, and the PCIe X8 slot and the PCIe X16 slot receive PCIe X4 devices or PCIe X8 devices. When the edge connector 16 is in accordance with PCIe X16 standards, the PCIe X4 slot receives a PCIe X4 device, the PCIe X8 slot receives a PCIe X4 device or a PCIe X8 device, and the PCIe X16 slot receives a PCIe X4 device, a PCIe X8 device, or a PCIe X16 device.

The second expansion card 300 includes a substantially rectangular circuit board 30. A plurality of PCIe slots 31-33, such as a PCIe X4 slot, a PCIe X8 slot, and a PCIe X16 slot, is arranged on the circuit board 30. In other embodiments, the number of the PCIe slots can be changed according to need. An edge connector 21 is arranged on a bottom edge 19 of the circuit board 30, to be electrically connected to pins 22 of a top of the expansion slot 20. The edge connector 21 includes a plurality of power pins 211, a plurality of ground pins 212, and a plurality of signal pins 213. The power pins 211 are connected to power pins of the PCIe slots 31-33. The ground pins 212 are connected to a ground layer (not shown) of the circuit board 30. The signal pins 213 are connected to signal pins of the PCIe slots 31-33. In one embodiment, the edge connector 21 is in accordance with PCIe X16 standards. In other embodiments, the edge connector 21 is in accordance with PCIe X4 standards or a PCIe X8 standards. When the edge connector 21 is in accordance with PCIe X4 standards, the PCIe X4 slot, the PCIe X8 slot, and the PCIe X16 slot of the circuit board 30 both receive PCIe X4 devices. When the edge connector 21 is in accordance with PCIe X8 standards, the PCIe X4 slot receives a PCIe X4 device, and the PCIe X8 slot and the PCIe X16 slot receive PCIe X4 devices or PCIe X8 devices. When the edge connector 21 is in accordance with PCIe X16 standards, the PCIe X4 slot receives a PCIe X4 device, the PCIe X8 slot receives a PCIe X4 device or a PCIe X8 device, and the PCIe X16 slot receives a PCIe X4 device, a PCIe X8 device, or a PCIe X16 device.

In use, when additional functionality is required, the first expansion card 100 is used. The edge connector 16 is inserted into the expansion slot 210, and then the PCIe devices can be selectively mounted on the PCIe slots 11-13 of the first expansion card 100. When the motherboard 200 receives power, the motherboard 200 outputs voltages and data signals to the PCIe slots 11-13 of the first expansion card 100 through the expansion slot 210 and the edge connector 16, to make the motherboard 200 communicate with the PCIe devices, which are inserted into the PCIe slots 11-13.

When more PCIe devices needs to be connected to the motherboard 200, and no on-board PCIe slots are available, the second expansion card 300 is selected. The edge connector 16 is inserted into the expansion slot 210, and then the edge connector 18 is inserted into the expansion slot 20 opposite to the pins 22. The pins 22 are soldered on the edge connector 21 of the second expansion card 300. The PCIe devices can be selectively mounted on the PCIe slots 11-13 of the first expansion card 100 and the PCIe slots 31-33 of the second expansion card 300. When the motherboard 200 receives power, the motherboard 200 outputs voltages and data signals to the PCIe slots 11-13 of the first expansion card 100 through the expansion slot 210 and the edge connector 16, to make the motherboard 200 communicate with the PCIe devices, which are inserted into the PCIe slots 11-13. At the same time, the motherboard 200 also outputs voltages and data signals to the PCIe slots 31-33 of the second expansion card 300 through the expansion slot 210, the edge connectors 16 and 18, the expansion slot 20, and the edge connector 21, to make the motherboard 200 communicate with the PCIe devices, which are inserted into the PCIe slots 31-33 of the second expansion card 300.

The expansion card assembly 1 can expand PCIe slots through the first expansion card 100, the expansion slot 20, and the second expansion card 300 when the number of the PCIe slots of the motherboard 200 are limited, to overcome a limited number of the PCIe slots of the motherboard 200.

Even though numerous characteristics and advantages of the disclosure have been set forth in the foregoing description, together with details of the structure and function of the disclosure, the disclosure is illustrative only, and changes may be made in detail, especially in matters of shape, size, and the arrangement of parts within the principles of the disclosure to the full extent indicated by the broad general meaning of the terms in which the appended claims are expressed.

What is claimed is:

1. An expansion card assembly, comprising:
a first expansion slot comprising a plurality of pins at a top of the first expansion slot;
a first expansion card comprising:
a first circuit board;
a plurality of first slots arranged on the first circuit board;
a first edge connector set on a bottom edge of the first circuit board and engaging in a second expansion slot of a motherboard, the first edge connector comprising a plurality of first power pins connected to power pins of each of the plurality of first slots, a plurality of first ground pins grounded, and a plurality of first signal pins connected to signal pins of each of the plurality of first slots; and
a second edge connector set on a top edge of the first circuit board and engaging in the first expansion slot opposite to the plurality of pins, the second edge connector comprising a plurality of second power pins connected to the plurality of first power pins, a plurality of second ground pins grounded, and a plurality of second signal pins connected to the plurality of first signal pins; and
a second expansion card comprising:
a second circuit board;
a plurality of second slots arranged on the second circuit board;
a third edge connector arranged on a bottom edge of the second circuit board and electrically connected to the plurality of pins of the first expansion slot, the third edge connector comprising a plurality of third power pins connected to power pins of each of the plurality of second slots, a plurality of third ground pins grounded, and a plurality of third signal pins connected to the plurality of signal pins of each of the second slots.

2. The expansion card assembly of claim 1, wherein the plurality of first slots is peripheral component interconnection express (PCIe) slots, the plurality of second slots is PCIe slots, the first expansion slot is a PCIe slot.

3. The expansion card assembly of claim 1, wherein the plurality of pins of the first expansion slot is soldered on the third edge connector.

4. The expansion card assembly of claim 1, wherein the plurality of first slots comprises PCIe X4 slots, PCIe X8 slots, and PCIe X16 slots, the plurality of second slots comprises PCIe X4 slots, PCIe X8 slots, and PCIe X16 slots.

5. The expansion card assembly of claim 1, wherein the first to third edge connectors are in accordance with PCIe X16 standards.
